(19) United States
(12) Patent Application Publication
(10) Pub. No.: US 2006/0016150 A1
(43) Pub. Date: Jan. 26, 2006

(54) Paperboard formwork and method for forming concrete structures

(76) Inventor: Andre Fournier, St. Germain (CA)

Correspondence Address: LESPERANCE & MARTINEAU, 1440 WEST, STE-CATHERINE ROOM 700, MONTREAL, QC, H3G1R8, CA

(21) Appl. No.: 10/896,044

(22) Filed: Jul. 22, 2004

(51) Int. Cl. E04G 21/02; E04G 13/02; B28B 7/34; B28B 7/36

(52) U.S. Cl. 52/745.17; 249/48; 249/61; 249/114.1

(57) ABSTRACT

A formwork for forming a concrete structure, comprising a rigid tubular envelope defining a peripheral inner wall circumscribing an axial hollow, further comprising a wall assembly nested within the axial hollow of the tubular envelope and including a number of wall parts defining inside and back surfaces. The back surface of each wall part bears against a corresponding section of the envelope inner wall, and the wall parts are arranged successively one relative to the other in peripheral coextensive fashion within the tubular envelope such that the inside surfaces, in combination, configure an axial forming cavity for receiving and forming a concrete column therein. The wall assembly further comprises an impervious liner applied to the inside surface of each wall part, providing an impervious barrier between the forming cavity and the inside surface of the wall parts.

### FIELD OF THE INVENTION

The present invention relates to shutterings and formworks, and more particularly to a paperboard formwork for forming concrete structures.

### BACKGROUND OF THE INVENTION

All liquid concrete that is still uncured needs to be contained, to hold the concrete in place until it hardens sufficiently to hold its own shape. With concrete slabs, the freshly-poured concrete may be retained by existing features such as upright walls, curbs, edgings, etc., or by some form of temporary shuttering also known as a “formwork”. The construction of formworks can be quite complicated and expensive, especially on vertical concrete structures such as vertical columns. Indeed, the cost of formworks generally represents a significant proportion of the total cost of the completed concrete structure.

Recently, the use of disposable formworks has been preferred over the use of permanent formworks made of an assembly of wooden or metal stakes, especially when forming vertical concrete structures such as upright columns. After concrete has been cast in a permanent formwork, the wooden or metal stakes cannot be removed before the concrete has at least partially solidified. Unfortunately, the concrete adheres to the stakes of the formwork once it has partially solidified, thus making the stake removal procedure a time-consuming and laborious task.

Many types of disposable formworks have been devised herein to date. For example, disposable formworks made of polystyrene (non-recyclable material) exist, but are plagued with environmental drawbacks. Indeed, when polystyrene formworks are used out in the open on a worksite, wind impinging on the formwork can cause the polystyrene to crumble into granules which eventually become scattered all over the worksite. Moreover, a polystyrene formwork becomes so deteriorated after a single usage that it cannot be used twice. Therefore, pollution occurs each time a polystyrene formwork is used since it must be discarded after a single use but cannot be recycled.

To obviate the environmental drawbacks of using polystyrene, recyclable paperboard has been used in the construction of formworks. Some paperboard formworks generally consist in a paperboard band, made of a plurality of laminated paper plies, wound helicoidally to form a cylindrical tube. The inner wall of the tube is coated with a liner of impervious material (e.g. a plastic sheet) to prevent the moisture of the concrete poured and setting up in the tube to penetrate across the paperboard and cause the delamination of its plies. Other paperboard formworks are structured from a tubular body composed of a number of assembled parts glued together at their interconnecting edges, and a band of reticulated material, e.g. fibreglass mesh, is rolled up helicoidally around the parts of the tubular body ensuring proper mechanical rigidity of the formwork.

However, most existing disposable formworks are still too expensive to produce, and their removal procedure after concrete hardening is laborious and time-consuming.

### SUMMARY OF THE INVENTION

The present invention relates to a formwork for forming an upright concrete structure, comprising:
a rigid tubular envelope defining a peripheral inner wall circumscribing an axial hollow;
a wall assembly removably nested into said tubular envelope axial hollow and comprising:
   a number of wall parts each defining an inside surface and a back surface, said back surface of each said wall part bearing against a corresponding section of said envelope inner wall, said wall parts being arranged successively one relative to the other in peripheral coextensive fashion within said tubular envelope such that said inside surfaces, in combination, configure an axial forming cavity for receiving and forming a concrete column therein; and
   an impervious liner applied to said inside surface of each said wall part, providing an impervious barrier between said forming cavity and said inside surfaces of said wall parts.

In one embodiment, the formwork further includes sliding means for said wall parts, said back surface of each said wall part slidably engages said envelope inner wall, said wall parts being thereby slidable relative to said tubular envelope, and said envelope defines an open first end mouth through which said wall assembly can pass to be slid in and out of said envelope.

In one embodiment, said impervious liner is applied to all said wall parts back surfaces in a continuous fashion and adheres thereto, said impervious liner thus binding said wall parts together to form said wall assembly integrally slidable relative to said envelope.

In yet another embodiment, said envelope has a cylindrical elongated shape.

In one embodiment, said wall assembly comprises four wall parts, so that said axial forming cavity is cross-sectionally quadrangular.

In yet another embodiment, said back surface of each said wall part is shaped so as to be wholly snugly engageable on corresponding sections of said envelope inner wall.

In one embodiment, each said wall part defines two opposite lateral edges, and a gap is defined between adjacent lateral edges of each pair of successive wall parts to expose said impervious liner.

The present invention also relates to a method for forming a concrete column, comprising the steps of:
(a) providing a formwork comprising a rigid tubular envelope defining a peripheral inner wall, further comprising a wall assembly removably nested within said tubular envelope and including a number of wall parts defining inside and back surfaces, said back surface of each said wall part bearing against a corresponding section of said envelope inner wall, said wall parts being arranged successively one relative to the other in peripherally coextensive fashion within said tubular envelope such that said inside surfaces in combination configure a forming cavity, said wall assembly further comprising an impervious liner applied to said inside surface of each said wall part and providing an impervious barrier between said forming cavity and said inside surface of said wall parts;
(b) pouring concrete in liquid-form into said forming cavity; and
(c) allowing for the concrete to harden enough at least for the concrete column to be self-supporting.

In one embodiment, this method further includes the steps (d) and (e) as follows:
(d) removing said envelope from around said wall assembly; and
(e) removing said impervious liner and said wall parts from the solidified concrete column.

In one embodiment, this method further includes, between steps (d) and (e), the step of cutting through said impervious liner to facilitate removal thereof from the hardened concrete column.

### DESCRIPTION OF THE DRAWINGS

In the annexed drawings:

FIG. 1 shows a front perspective view of a paperboard formwork according to one embodiment of the present invention;

FIG. 2 shows a cross-sectional view of the formwork taken along lines II-II of FIG. 1;

FIG. 3 shows an enlarged perspective view of the formwork of FIG. 1, with the wall assembly being partially extracted from the tubular envelope of the formwork for clarity of the view; and

FIG. 4 shows a broken enlarged view of one of the four wall parts of the formwork of FIG. 1, its inside and back surfaces being broken to more clearly show its inner paperboard honeycomb-pattern structure.

### DETAILED DESCRIPTION OF THE EMBODIMENTS

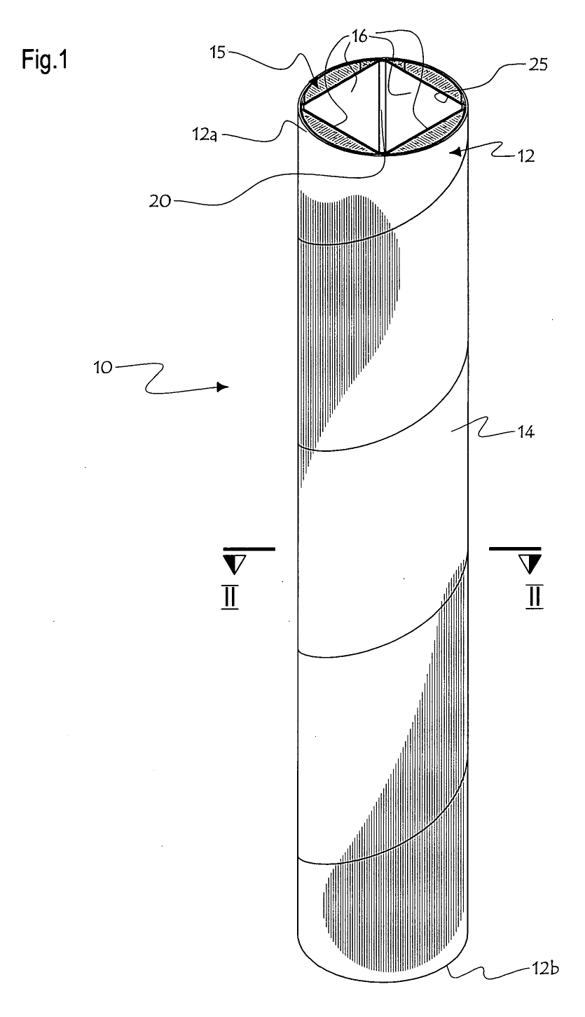

A disposable paperboard formwork 10 according to the present invention is shown in FIGS. 1-3. Although it could be used with any suitable environmental material, the present formwork will be described as being used for forming structures, and especially columns, made of concrete.

Formwork 10 comprises a rigid, elongated and cylindrical tubular envelope 12 defining top and bottom end mouths 12a and 12b, and a peripheral inner wall 13 circumscribing an axial hollow. The top end mouth 12a of envelope 12 can remain open or can present some sort of opening, closable or not, to allow fresh liquid concrete to be poured in the formwork, and the bottom end mouth 12b can either be opened or closed off using a suitable sealing element such as an integral discoid closure plate (not shown). In the embodiment shown in the figures, tubular envelope 12 is made of a helicoidally-wound paperboard band 14 composed of a number of laminated paper plies suitably adhered together.

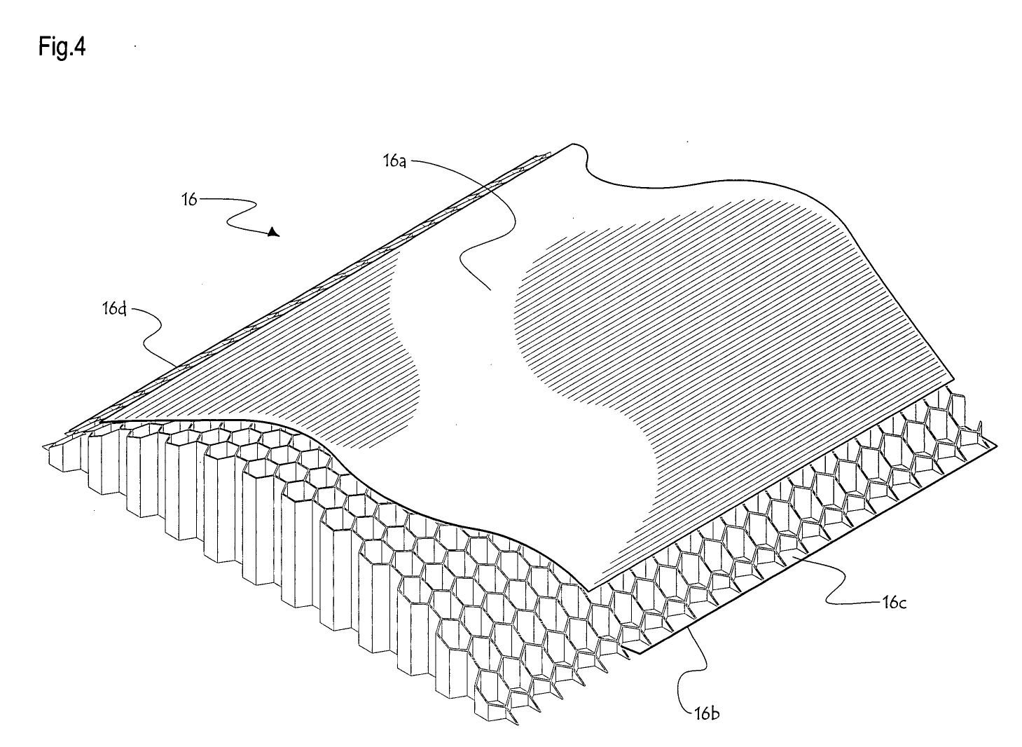

An elongated wall assembly 15 is lengthwisely nested in elongated tubular envelope 12 and is circumscribed by the latter's inner wall 13. Wall assembly 15 defines a forming cavity 20 therein, and comprises a number (for example four in the drawings) of elongated wall parts 16 which can be made of honeycomb-pattern cardboard (FIG. 4) for example. The radially outward back surface 16a of each wall part 16 bears against envelope inner wall 13 and is slidable relative thereto, and is shaped to provide a stable engagement of the corresponding wall part 16 about envelope inner wall 13. In the embodiment shown in the drawings, back surface 16a cross-sectionally defines a circular arc having a radius matching that of cylindrical envelope inner wall 13, which allows each wall part 16 to snugly engage envelope inner wall 13. It is however understood that in alternate embodiments of the present invention, the back surface of the wall parts could have any suitable shape as long as it provides the wall part with an abutment surface stably engageable on the inner wall of the tubular envelope.

Wall parts 16 are suitably disposed in a peripheral coextensive fashion within envelope 12 such that the radially inward inside surfaces 16b of all four wall parts 16 delimit, in combination, a quadrangular axial forming cavity 20. The forming cavity 20 has the dimensions and shape of the concrete column to be obtained with the formwork 10. In the embodiment shown in the drawings, wall assembly 15 comprises four wall parts 16 having a planar inside surface 16b configuring, in combination, a cross-sectionally square forming cavity 20. However, all other suitable shapes are within the scope of the invention.

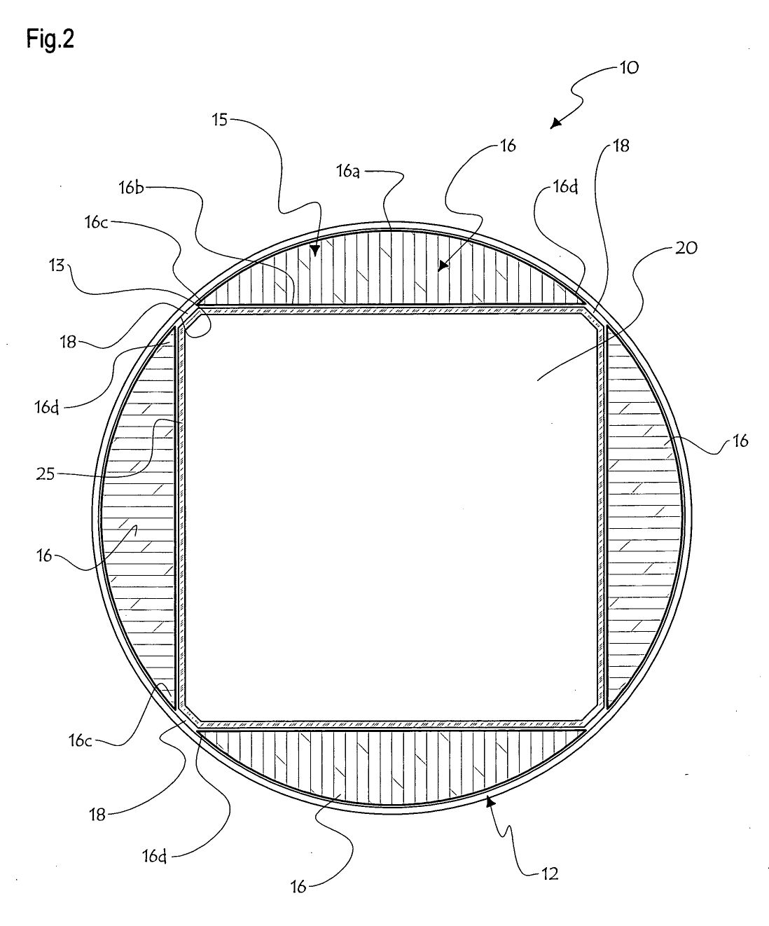

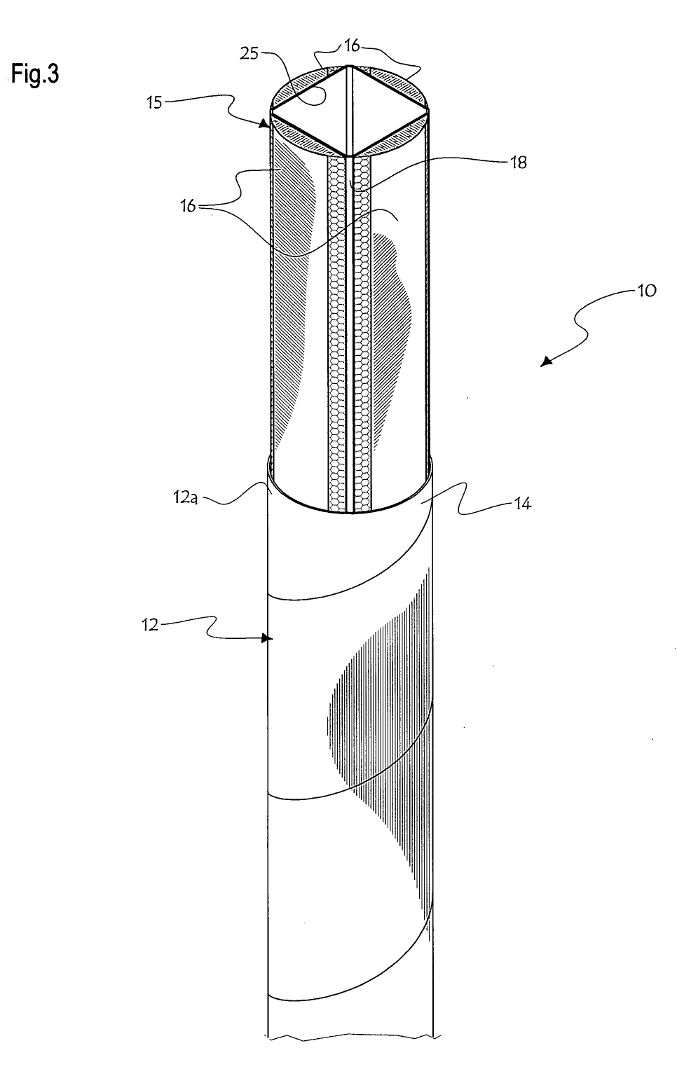

A plastic liner 25 is deposited, using a suitable plastic-spraying technique for example, on the inside surface 16b of wall parts 16 and is adhered thereto. Liner 25 can be made of a watertight material other than plastic, as long as it provides an impervious barrier between forming cavity 20 and wall parts 16. Liner 25 can be applied in a continuous fashion between all four wall parts 16, filling gaps 18 between juxtaposed edges 16c and 16d of adjacent wall parts 16, 16, as can be seen in FIG. 2. Adhering liner 25 in a continuous fashion to the inside surfaces 16b of the four wall parts 16 interconnects the four wall parts 16 to form wall assembly 15, which can slidably integrally move in and out of tubular envelope 12. Wall assembly 15 can be seen in a retracted position within envelope 12 in FIG. 1, and in an extracted position in FIG. 3. When the wall assembly 15 moves in or out of envelope 12, the back surface 16a of wall parts 16 slides about envelope inner wall 13. When wall assembly 15 is extracted from tubular envelope 12, impervious liner 25 is exposed between adjacent wall parts 16 through gaps 18 as seen in FIG. 3; this will be useful during removal of the formwork from around the hardened concrete column after concrete setting.

Alternate embodiments could also be envisioned where the impervious liner is closely applied on the inside surface of the wall parts without adhering thereto.

The procedure to be followed to form a concrete column using the formwork of the present invention will now be described.

Firstly, a formwork 10 is set up lengthwisely vertically at the desired location. Moist, liquid-form concrete is then poured inside forming cavity 20 and progressively fills it.

A certain amount of time then has to elapse for the concrete to dry and harden before removal of the formwork. During the hardening phase of the concrete column, of course, no water escaping from the moist freshly-poured concrete can penetrate into the paperboard material of the wall parts 16 and of envelope 12, since it cannot permeate across impervious liner 25.

Once the concrete cast in the formwork has hardened sufficiently to be self-supporting and hold its own shape, formwork 10 can be removed from the hardened column. First, the envelope 12 is pulled away from the wall assembly 15, which contains the hardened concrete column, until envelope 12 clears wall assembly 15. A technique for doing so could be for example to tie the top end portion of envelope 12 to a rope connected to a hoisting system, and to hoist envelope 12 up to pull it away from wall assembly 15. Of course, any other suitable technique could also be used to remove envelope 12 from around wall assembly 15, such as ripping envelope 12 open.

During hardening of the concrete column, the impervious liner 25 generally clings to the concrete column. Therefore, impervious liner 25 has to be cut using a suitable cutting device, in order to allow it to be torn and detached from the concrete column. To achieve this, the cutting device can be positioned in gap 18 between edges 16c and 16d of two adjacent wall parts 16 to make a cut in impervious liner 25 along its whole length, from the top to the bottom of the hardened concrete column. To avoid scarring of the concrete column, a blunt-edged blade can be used to cut through impervious liner 25. Once a longitudinal cut has been made lengthwisely along impervious liner 25, impervious liner 25 can be torn and removed from the hardened concrete column, carrying along the four paperboard wall parts 16 adhered thereto. Of course, any other suitable removal technique could be used to remove the impervious liner and the wall parts from the hardened concrete column.

The formwork of the present invention comprises a number of advantages over the prior art. In particular, it can withstand high amounts of mechanical stress. When liquid-form concrete is poured inside the forming cavity of a formwork, the liquid concrete applies substantial pressure on the peripheral surface of the forming cavity; this pressure is of course most important at the base of the formwork, as is the case with any liquid-filled container.

Some prior art disposable formworks include a number of wall parts disposed and glued edge to edge. With such prior art formworks, the load arising from concrete-applied pressure is concentrated at the glue joint located between interconnecting edges of the wall parts. This glue joint being generally unable by itself to hold the wall parts together against the weight bias of the freshly-poured concrete, a band of reticulated material, e.g. fibreglass mesh, needs to be added and generally rolled up helicoidally around the wall parts to ensure mechanical rigidity of the formwork. The fibreglass mesh portions overlapping interconnected wall part edges, when liquid-form concrete is poured in the formwork, are nevertheless subjected to very important tensile loads, especially in the base region of the formwork.

With the formwork of the present invention, the wall parts 16 are fitted within a rigid paperboard envelope 12, and the back surface 16a of the wall parts snugly engages the inner wall 13 of the rigid tubular envelope 12. The pressure applied by the freshly-poured concrete biasing the wall parts 16 away from each other and against envelope 12, is evenly distributed along the entire circumference of the inner wall 13 of tubular envelope 12, as opposed to prior art formworks where this pressure is concentrated in the regions around the interconnecting edges of the wall parts. This pressure being distributed evenly around envelope inner wall 13, the formwork can adequately resist to the load of freshly-poured concrete, without recourse to glue or bands of reticulated material to hold the wall parts together, thus keeping production costs to a minimum.

The formwork of the present invention also obviates the environmental drawbacks of using disposable polystyrene formworks. Indeed, the envelope and wall parts of the formwork are made from paper-based materials, and the impervious liner is generally made of plastic, which are all recyclable materials as opposed to polystyrene. Moreover, as mentioned above in the “Background of the invention” section, wind impinging on polystyrene formworks can cause the polystyrene to crumble into granules which eventually become scattered all over the worksite; this problem is obviated with the cardboard formwork of the present invention. Moreover, in the present invention, the tubular envelope carefully slid away from the wall assembly after the concrete has solidified therein is destined to be reused. A blank wall assembly can be inserted in the recuperated envelope 12 to produce a new formwork. The present invention thus has the advantage of being partly reusable, as opposed to prior art paperboard formworks which must be torn apart during removal from the hardened concrete column, and entirely discarded thereafter.

Of course, the shape and number of wall parts could be modified to obtain different shapes of concrete columns. For example, the wall assembly could comprise six wall parts of identical dimensions (instead of four), arranged edge-to-edge within envelope 12 to form a cross-sectionally hexagonal forming cavity, for forming concrete columns of hexagonal cross-sections. With the present formwork, it is therefore possible to form columns of different shapes by modifying only the arrangement and/or shape of the wall parts of the wall assembly, while keeping the same tubular envelope, thus keeping production costs to a minimum.

Also, it is understood that the tubular envelope can have any suitable shape. To form a cross-sectionally oblong column, e.g. of rectangular cross-section, the tubular envelope may have a cross-sectionally oblong shape, e.g. of elliptical cross-section.

The present invention also relates to a method for forming a concrete column, comprising:
(a) pouring concrete in liquid-form into the forming cavity, within the wall assembly of the formwork;
(b) allowing for the concrete to harden enough at least for the concrete column to be self-supporting;
(c) removing the envelope from around the wall assembly;
(d) cutting through the impervious liner; and
(e) removing the impervious liner and the wall parts from the solidified concrete column.

1. A formwork for forming an upright concrete structure, comprising:
a rigid tubular envelope defining a peripheral inner wall circumscribing an axial hollow;
a wall assembly removably nested into said tubular envelope axial hollow and comprising:
a number of wall parts each defining an inside surface and a back surface, said back surface of each said wall part bearing against a corresponding section of said envelope inner wall, said wall parts being arranged successively one relative to the other in peripheral coextensive fashion within said tubular envelope such that said inside surfaces, in combination, configure an axial forming cavity for receiving and forming a concrete column therein; and
an impervious liner applied to said inside surface of each said wall part, providing an impervious barrier between said forming cavity and said inside surfaces of said wall parts.

2. The formwork according to claim 1,
further including sliding means for said wall parts, wherein said back surface of each said wall part slidably engages said envelope inner wall, said wall parts being thereby slidable relative to said tubular envelope, and wherein said envelope defines an open first end mouth through which said wall assembly can pass to be slid in and out of said envelope.

3. The formwork according to claim 2,
wherein said impervious liner is applied to all said wall parts back surfaces in a continuous fashion and adheres thereto, said impervious liner thus binding said wall parts together to form said wall assembly integrally slidable relative to said envelope.

4. The formwork according to claim 1,
wherein said envelope has a cylindrical elongated shape.

5. The formwork according to claim 1,
wherein said wall assembly comprises four wall parts, so that said axial forming cavity is cross-sectionally quadrangular.

6. The formwork according to claim 1,
wherein said back surface of each said wall part is shaped so as to be wholly snugly engageable on corresponding sections of said envelope inner wall.

7. The formwork according to claim 1,
wherein each said wall part defines two opposite lateral edges, and a gap is defined between adjacent lateral edges of each pair of successive wall parts to expose said impervious liner.

8. The formwork according to claim 1,
wherein said rigid tubular envelope and said wall parts are made of a paper-based, recyclable material.

9. A method for forming a concrete column, comprising the steps of:
(a) providing a formwork comprising a rigid tubular envelope defining a peripheral inner wall, further comprising a wall assembly removably nested within said tubular envelope and including a number of wall parts defining inside and back surfaces, said back surface of each said wall part bearing against a corresponding section of said envelope inner wall, said wall parts being arranged successively one relative to the other in peripherally coextensive fashion within said tubular envelope such that said inside surfaces in combination configure a forming cavity, said wall assembly further comprising an impervious liner applied to said inside surface of each said wall part and providing an impervious barrier between said forming cavity and said inside surface of said wall parts;
(b) pouring concrete in liquid-form into said forming cavity; and
(c) allowing for the concrete to harden enough at least for the concrete column to be self-supporting.

10. The method for forming a concrete column according to claim 9,
further including the steps (d) and (e) as follows:
(d) removing said envelope from around said wall assembly; and
(e) removing said impervious liner and said wall parts from the solidified concrete column.

11. The method for forming a concrete column according to claim 10,
further including, between steps (d) and (e), the step of cutting through said impervious liner to facilitate removal thereof from the hardened concrete column.
